(19) United States
(12) Patent Application Publication
(10) Pub. No.: US 2014/0132528 A1
(43) Pub. Date: May 15, 2014

(54) AIRCRAFT HAPTIC TOUCH SCREEN AND METHOD FOR OPERATING SAME

(71) Applicant: GE AVIATION SYSTEMS LIMITED, Cheltenham (GB)

(72) Inventor: Lewis William Catton, Beckford (GB)

(73) Assignee: GE Aviation Systems Limited, Cheltenham (GB)

(21) Appl. No.: 13/861,713

(22) Filed: Apr. 12, 2013

(30) Foreign Application Priority Data
Nov. 9, 2012 (GB) 12202180

(51) Int. Cl. G06F 3/01; G08G 5/00

(52) U.S. Cl. CPC G06F 3/016; G08G 5/0095
USPC 345/173

(57) ABSTRACT

An aircraft flight deck for controlling the flight operations of an aircraft, includes at least one touch screen having multiple user inputs and at least some of the multiple user inputs are haptic inputs, which provide a haptic response to a touch and methods of operating an aircraft having a flight deck with a haptic touch screen display having multiple haptic inputs, with each input providing a haptic response may include detecting a touch of one of the haptic inputs to define a selection and outputting a haptic response based on the selection.

### CROSS-REFERENCE TO RELATED APPLICATIONS

This application claims priority under 35 U.S.C. §119 to British Patent Application No. 12202180, filed Nov. 9, 2012, the disclosure of which is incorporated herein by reference.

### BACKGROUND OF THE INVENTION

In contemporary aircraft cockpits touch screen displays, i.e. touch screens, may be used to control various features of the aircraft. Such touch screens may rely on sounds or a visual indication to indicate that the user's touch of an input on the screen was recognized. Even a small delay of this recognition of a selected input can leave the user unsure if an input selection was made.

### BRIEF DESCRIPTION OF THE INVENTION

In one embodiment, the invention relates to an aircraft flight deck for controlling the flight operations of an aircraft, including at least one touch screen having multiple user inputs and at least some of the multiple user inputs are haptic inputs, which provide a haptic response to a touch, wherein the haptic response for a haptic input is determined based on a categorization of a severity of the corresponding user input to the operation of the aircraft.

In another embodiment, the invention relates to a method of operating an aircraft having a flight deck with a haptic touch screen display having multiple haptic inputs, with each input providing a haptic response, the method including detecting a touch of one of the haptic inputs to define a selection, determining a severity of the selection on operation of the aircraft according to a predetermined categorization, and outputting a haptic response based on the determined severity.

In yet another embodiment, the invention relates to a method of operating an aircraft having a flight deck with a haptic touch screen display having multiple haptic inputs, with each input providing a haptic response, the method comprising detecting a touch of one of the haptic inputs to define a selection, where the haptic inputs are categorized according to a severity the haptic inputs have on operation of the aircraft and outputting a haptic response based on the selection.

### BRIEF DESCRIPTION OF THE DRAWINGS

In the drawings:

FIG. 1 is a perspective view of a portion of an aircraft cockpit with a flight deck having a touch screen display according to an embodiment of the invention.

FIG. 2 is an enlarged view of the touch screen of FIG. 1.

### DESCRIPTION OF EMBODIMENTS OF THE INVENTION

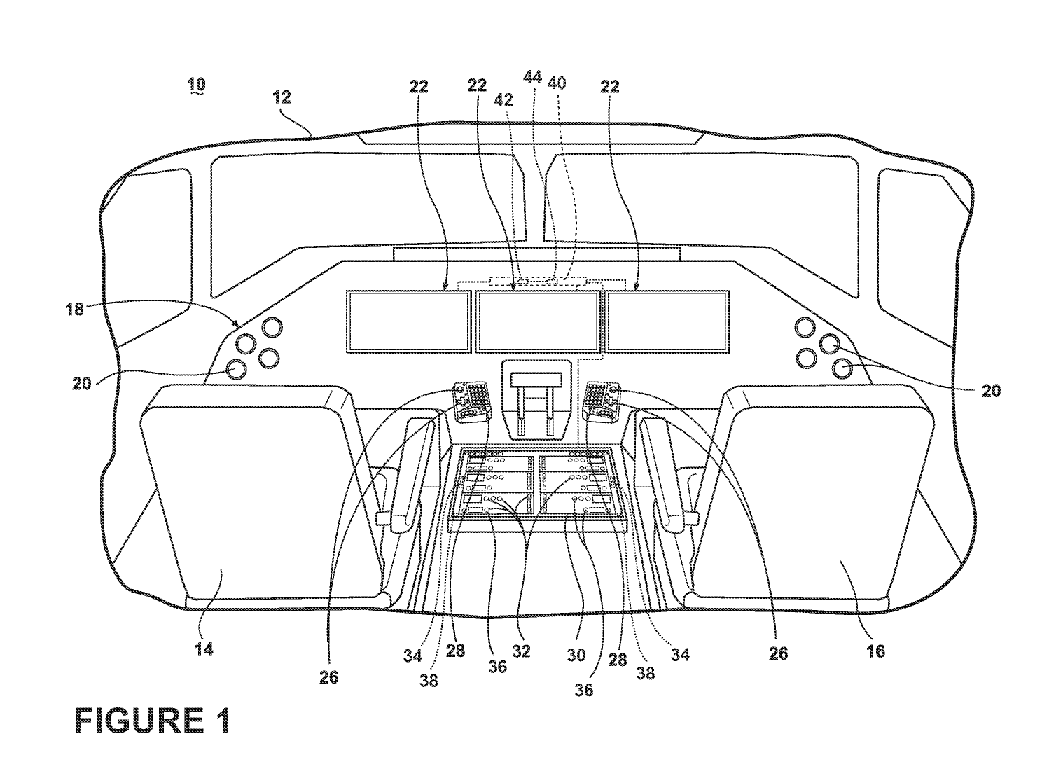

FIG. 1 illustrates a portion of an aircraft 10 having a cockpit 12. While a commercial aircraft has been illustrated, it is contemplated that embodiments of the invention may be used in any type of aircraft, for example, without limitation, fixed-wing, rotating-wing, rocket, personal aircraft, and military aircraft. A first user (e.g., a pilot) may be present in a seat 14 at the left side of the cockpit 12 and another user (e.g., a co-pilot) may be present at the right side of the cockpit 12 in a seat 16. A flight deck 18 having various instruments 20 and multiple multifunction flight displays 22 may be located in front of the pilot and co-pilot and may provide the flight crew with information to aid in flying the aircraft 10. The flight displays 22 may include either primary flight displays or multi-function displays and may display a wide range of aircraft, flight, navigation, and other information used in the operation and control of the aircraft 10.

The flight displays 22 have been illustrated as being in a spaced, side-by-side arrangement with each other. The flight displays 22 may be laid out in any manner including having fewer or more displays. Further, the flight displays 22 need not be coplanar and need not be the same size.

It is contemplated that one or more cursor control devices 26 and one or more multifunction keyboards 28 may be included in the cockpit 12 and may also be used by one or more flight crew members to interact with the systems of the aircraft 10. A suitable cursor control device 26 may include any device suitable to accept input from a user and to convert that input to a graphical position on any of the multiple flight displays 22. Various joysticks, multi-way rocker switches, mice, trackballs, and the like are suitable for this purpose and each user may have separate cursor control device(s) 26 and keyboard(s) 28.

At least one touch screen 30 may be included in the flight deck 18 and may be used by one or more flight crew members, including the pilot and co-pilot, to interact with the systems of the aircraft 10. In the illustrated example, the touch screen 30 is located in the inter-seat console area; however, it will be understood that the touch screen 30 may be located in other areas of the flight deck 18. Such a touch screen 30 may take any suitable form including that of a liquid crystal display (LCD). Multiple user inputs 32 may be included on the touch screen 30. Such multiple user inputs 32 may dynamically change or may remain the same.

The touch screen 30 may use various physical or electrical attributes to sense inputs from the flight crew. For example, one or more sensors 34 may be operably coupled to the touch screen 30 and configured to sense a selection of one of the multiple user inputs 32. The sensor 34 may be of any suitable type including capacitive, resistive, etc.

At least some of the multiple user inputs 32 may be haptic inputs 36, which provide a haptic response to a touch or selection by a user. A haptic response may be any suitable physical feedback from the touch screen 30 to the user upon the recognition of a touch or selection by a user. It is contemplated that all of the user inputs 32 may be haptic inputs 36. It is also contemplated that haptic inputs 36 may be included for portions of the touch screen 30 that are not identified as user inputs 32. One or more actuators 38 may be operably coupled to the touch screen 30 to provide haptic responses to a user touching the haptic inputs 36 on the touch screen 30. By way of non-limiting example, the actuators 38 may be, piezoelectric actuators coupled to an underside of the touch screen 30. Regardless of the type of actuator the one or more actuators 38 may be located adjacent the touch screen in any suitable manner. For example, a single actuator 38 may be positioned at or near the center of the touch screen 30. Alternatively, the actuator 38 may be to one side of the touch screen 30. In the illustrated embodiment, multiple actuators 38 are positioned at different areas of the touch screen 30 including that an actuator 38 is located at each of the corners of the touch screen 30. The actuators could be positioned throughout the display.

Using one or more actuators 38 as controlled by a controller 40, a variety of haptic responses can be output to the user who is touching the touch screen 30. For example, jolts, vibrations, which may have varying magnitude or a constant magnitude and varying frequency or constant frequency, or waves such as sine, square, and sawtooth waves, etc. may be output. It is contemplated that the haptic response output for the haptic input 36 may be based on a categorization of a severity of the corresponding user input 32 to the operation of the aircraft 10. The haptic response can be varied; for example, the frequency of a vibration output by an actuator 38 can be varied by providing different control signals to the actuator 38. Furthermore, the magnitude of the pulse, vibration, or wave can be varied based on the categorization. In the illustrated case, where multiple actuators 38 are included, different haptic responses may be obtained by activating some but not all of the actuators. For example, a stronger vibration can be imparted on the touch screen 30 by activating two or more actuators 38 simultaneously. In this manner, the controller 40 can control the physical response of the actuator 38 to differentiate the physical response provided. The controller 40 may also allow a user to set the frequency, waveform, magnitude, etc., allowing these characteristics to be controllable.

The controller 40 may be operably coupled to components of the aircraft 10 including the various instruments 20, flight displays 22, cursor control devices 26, keyboards 28, touch screen 30, sensor 34, and actuators 38. The controller 40 may also be connected with other controllers and systems of the aircraft 10. The controller 40 may include memory 42 and processing units 44, which may be running any suitable programs to implement a graphical user interface (GUI) and operating system. These programs typically include a device driver that allows the user to perform functions on the touch screen 30 including selecting the multiple user inputs 32 and haptic inputs 36. This may include selecting and opening files, moving icons, selecting options, and inputting commands and other data through the touch screen 30. The sensor 34 may provide information to the controller 40 including what multiple user inputs 32 and haptic inputs 36 have been selected. Alternatively, the controller 40 may process the data output from the sensor 34 and determine from the output what multiple user inputs 32 and haptic inputs 36 have been selected. The controller 40 may also receive inputs from one or more other additional sensors (not shown), which may provide the controller 40 with various information to aid in the operation of the aircraft 10.

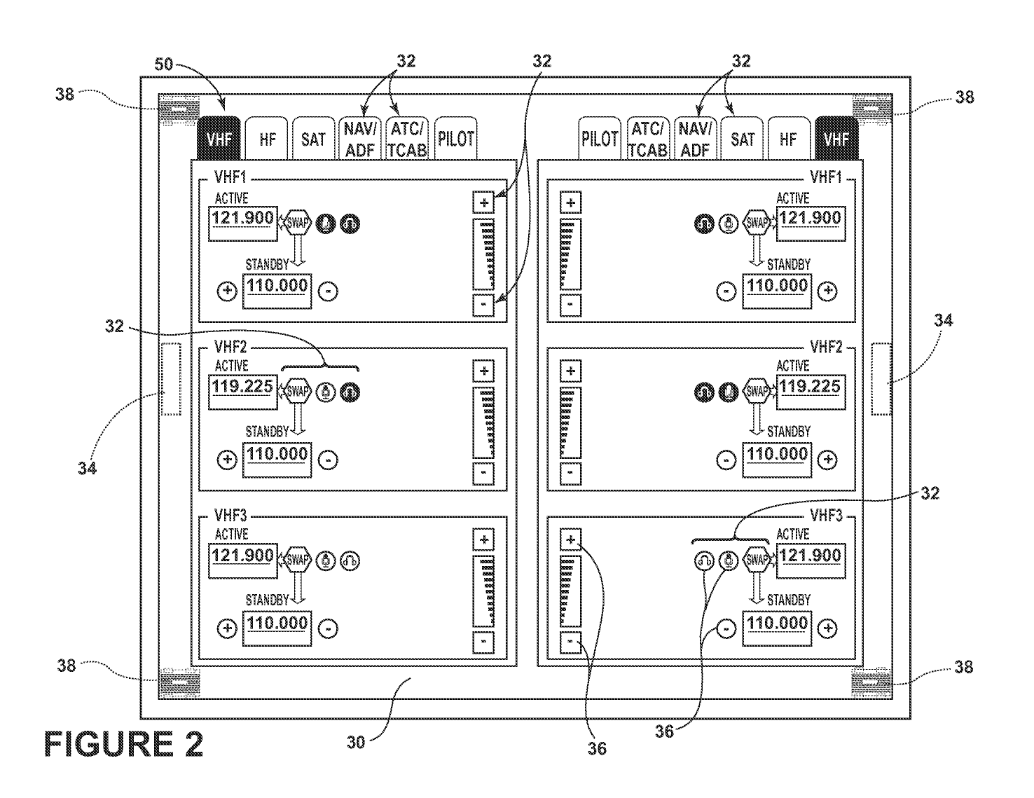

FIG. 2 more clearly illustrates the touch screen 30 with a variety of exemplary user inputs 32 and haptic inputs 36. Menu headings 50 are displayed at the top and may be selected by a user to switch between graphical displays related to each menu heading 50. The exemplary illustration illustrates a variety of VHF data link controls for sending information between aircraft and ground stations.

During operation, the controller 40 may determine what haptic input 36 has been selected and may determine a haptic response for the haptic input based on a categorization of a severity of the corresponding user input to the operation of the aircraft. In one exemplary embodiment, the controller 40 may be configured to determine the category of a sensed selection and cause a haptic feedback to be output to the touch screen 30 via the actuator 38 based on the determined category. The haptic inputs 36 may be categorized by the controller 40 into one of a menu function, a menu action, a hard action, an error action, etc. Each of these categories may have a differing severity on the operation of the aircraft 10.

For example, the menu function may have an effect only on the menu itself; for example, this may include changing a menu function from standby to active. With respect to the exemplary haptic inputs 36 illustrated in FIG. 2, a selection of a menu heading 50 may be categorized as a menu function and may have no impact on the operations of the aircraft 10. The controller may output a haptic response such as a pulse to indicate that the selection has registered. A menu action may include navigating through the menu or selecting an option on the menu. With respect to the exemplary haptic inputs 36 illustrated in FIG. 2, changing of the band designation on a standby channel may be categorized as a menu action and may have no impact on the operations of the aircraft 10. The controller 40 may output a haptic response such as a pulse to indicate that the selection has registered. The haptic response for the menu function and the menu action may be the same.

A hard action has an effect on a system of the aircraft 10 or may somehow change the profile of the aircraft 10. For example, a hard action may include shutting off a fuel pump, lowering landing gear, changing fuel in the fuel tanks, selecting a temporary flight plan as a flight plan to be executed, acknowledgment of a cockpit warning, hand-off of control of the aircraft to a ground-based or autonomous agent. In the illustrated example, selecting to swap one of the active channels for a stand by channel may be categorized as a hard action as it has an effect on what band is being used to transmit data to and from the aircraft 10. The controller 40 may output a haptic response that is more severe than the haptic response for the menu function and the menu action. By way of non-limiting example, the haptic response for the hard action may be a vibration having an increasing magnitude.

An error action may relate to a selection that is not available as an option or a data entry that is inacceptable. For example, an error action may include a mistyped waypoint that is not in the database, etc. In the illustrated example, selecting to swap a standby band designation that is the same band designation as the active channel may be categorized as an error action. Further, during data entry when a user types an invalid letter or number using an onscreen control such as a keyboard, a number pad, or a scroll button, such a selection may be categorized as an error action. Further still, selection of a menu page for a system which is inoperative may be categorized as an error action.

The haptic inputs 36 may also be portions of the touch screen 30 where a user input 32 is not indicated. For example, a user may attempt to press an area of the touch screen 30 when only limited options are available. For example, when a warning must be acknowledged and there is no other valid user entry, a touch on any area of the touch screen 30 besides the acknowledge input would be categorized as an error action.

Regardless of the type of error action, when the selection is an error action, the controller 40 may output a haptic response that is more severe than the haptic response for the hard action. By way of non-limiting example, the haptic response for the error action may be a sine wave having an increasing magnitude and frequency or a vibration having an increased magnitude through the use of more actuators 38.

In all of the described embodiments, the haptic inputs may be categorized into one of a menu function, a menu action, a hard action, and an error action. The haptic response output for a hard action may be more severe than for a menu function and a menu action. The haptic response output for the error action may be more severe than the haptic response for the hard action. This is because each category selection may have a different severity on the operation of the aircraft 10. Regardless of whether the above haptic inputs are categorized into the various actions or not, the haptic input may be categorized as having one of no impact, effect on a system, and an error event. It is contemplated that the haptic response output for a selection that has an effect on a system is more severe than for a no impact selection. Furthermore, the haptic response output for the error event selection may be more severe than the haptic response for the effect on a system selection.

The below described embodiments of the inventive methods operate the aircraft 10 in a variety of ways to output a haptic response based on the determined severity the input has on the operation of the aircraft. One embodiment may determine a severity of the selection on operation of the aircraft 10 according to a predetermined categorization of the inputs. For example, a method of operating the aircraft 10 may include detecting a touch of one of the haptic inputs. This may include sensing an object touching on the touch screen 30 to define a selection. The controller 40 may then determine a severity of the selection on operation of the aircraft according to a predetermined categorization. For example, the controller 40 may determine if the haptic input has no impact on the operation of the aircraft, effect on a system of the aircraft, or if the haptic input is an error event. A haptic response may then be output based on the determined severity. More specifically, the one or more actuators 38 may be operated to provide a haptic response based on the determined severity.

Another embodiment may alternatively include that the haptic responses for each different type of category may be hardwired to the haptic input 36. In such an instance, it would merely be required that a touch of one of the haptic inputs 36 be detected to define a selection and an appropriate haptic response would be output. The haptic inputs 36 would be categorized according to a severity the haptic inputs have on operation of the aircraft at the time the haptic inputs 36 were hardwired for a haptic response.

The above described embodiments allow for the use of a touch screen that can facilitate rapid interaction and can provide an intuitive Human-Machine Interface (HMI) to the crew. The above described embodiments provide for a variety of benefits including increased user confidence in selections on the touch screen. In the flight deck, the objective is to minimize the amount of time that the crew needs to spend looking at the touch screen; this is particularly true if the touch screen is located in the inter-seat console. The above describe embodiments provide different haptic response for different selections by the user allowing the user to sense what their selection does to the operation of the aircraft.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft flight deck for controlling flight operations of an aircraft, comprising:
at least one touch screen having multiple user inputs; and
at least some of the multiple user inputs are haptic inputs, which provide a haptic response to a touch;
wherein the haptic response for a haptic input is determined based on a categorization of a severity of the corresponding haptic input to operation of the aircraft.

2. The aircraft flight deck of claim 1 wherein the haptic inputs are categorized into one of a menu function, a menu action, a hard action, and an error action.

3. The aircraft flight deck of claim 2 wherein the haptic response for a hard action is more severe than the haptic response for a menu function and a menu action.

4. The aircraft flight deck of claim 3 wherein the haptic response for the error action is more severe than the haptic response for the hard action.

5. The aircraft flight deck of claim 1 wherein the severity of the corresponding haptic input to the operation of the aircraft may be categorized as one of no impact, effect on a system, and an error event.

6. The aircraft flight deck of claim 5 wherein the haptic response for the error event is more severe than the haptic response for the effect on a system.

7. A method of operating an aircraft having a flight deck with a haptic touch screen display having multiple haptic inputs, with each input providing a haptic response, the method comprising:
detecting a touch of one of the haptic inputs to define a selection;
determining a severity of the selection on operation of the aircraft according to a predetermined categorization; and
outputting a haptic response based on the determined severity.

8. The method of claim 7 wherein the haptic inputs are categorized into one of a menu function, a menu action, a hard action, and an error action.

9. The method of claim 8 wherein the haptic response output for a hard action is more severe than for a menu function and a menu action.

10. The method of claim 9 wherein the haptic response output for the error action is more severe than the haptic response for the hard action.

11. The method of claim 7 wherein when the severity of the selection on the operation of the aircraft is categorized as one of no impact, effect on a system, and an error event.

12. The method of claim 11 wherein the haptic response output for effect on a system selection is more severe than for a no impact selection.

13. The method of claim 12 wherein the haptic response output for the error event selection is more severe than the haptic response for the effect on a system selection.

14. A method of operating an aircraft having a flight deck with a haptic touch screen display having multiple haptic inputs, with each input providing a haptic response, the method comprising:
detecting a touch of one of the haptic inputs to define a selection, where the haptic inputs are categorized according to a severity the haptic inputs have on operation of the aircraft; and
outputting a haptic response based on the selection.

15. The method of claim 14 wherein the severity is categorized as one of no impact haptic input, effect on a system haptic input, and an error event haptic input.

16. The method of claim 15 wherein the haptic response output for the effect on a system haptic input is more severe than for the no impact haptic input.

17. The method of claim 16 wherein the haptic response output for the error event haptic input is more severe than the haptic response for the effect on a system haptic input.
